(19) United States
(12) Patent Application Publication
(10) Pub. No.: US 2009/0049442 A1
(43) Pub. Date: Feb. 19, 2009

(54) DATA PROCESSING APPARATUS AND SOFTWARE PROGRAM ACTIVATION METHOD

(75) Inventor: Shin Shimasaki, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/191,210

(22) Filed: Aug. 13, 2008

(30) Foreign Application Priority Data
Aug. 14, 2007 (JP) 2007-211453(PAT.)

(51) Int. Cl. G06F 9/445

(52) U.S. Cl. 717/174

(57) ABSTRACT

A data processing apparatus includes an installation unit configured to install software programs, an activation unit configured to activate a plurality of software programs including one or more software programs installed by the installation unit to complete an installation work for the one or more software programs, and a display unit configured to cause a display device to display an image relating to the software program activated by the activation unit. The display unit displays a screen relating to the plurality of software programs activated by the activation unit according to a display pattern corresponding to the plurality of software programs, to prevent a screen display for the software programs whose installation work is already completed from interfering with user's operation for software program newly installed by the installation unit on an initial setting screen.

### BACKGROUND OF THE INVENTION

1. Field of the Invention

The present invention relates to a data processing apparatus and a software program activation method, which can be used to install various software programs.

2. Description of the Related Art

The integrated installer is software program that enables a user of a printer to install a plurality of software programs and electronic manuals provided for the printer. The integrated installer is usable to successively install a plurality of software programs.

The integrated installer requires rebooting of the operating system (OS) depending on the type of software program to be installed. After the OS is rebooted to install software program(s), the integrated installer continuously executes processing for accomplishing installation of the rest of the software programs to be installed. Hence, as discussed in Japanese Patent Application Laid-Open No. 2004-302929, the integrated installer performs automatic startup registration for the integrated installer itself and manages the progress of software program installation to continuously execute the processing even when the processing of the integrated installer is interrupted by the rebooting of the OS.

As described above, the processing by the integrated installer requires activation of a plurality of software programs when the OS is rebooted. Furthermore, if software program is newly installed in a state where a computer already incorporates software program(s) that automatically start up in response to rebooting of the OS, the computer is required to activate a plurality of software programs. In this manner, when a conventional system activates a plurality of software programs in response to rebooting of the OS, the system causes the OS to successively activate the plurality of software programs irrespective of the contents of the plurality of software programs. Furthermore, if a computer is configured to display images relating to a plurality of software programs that are activated, the computer controls the display of images individually according to respective software programs.

### SUMMARY OF THE INVENTION

Exemplary embodiments of the present invention are directed to a data processing apparatus and a software program activation method, which can be used to install various software programs.

According to an aspect of the present invention, a data processing apparatus includes an installation unit configured to install software programs, an activation unit configured to activate a plurality of software programs including one or more software programs installed by the installation unit to complete an installation work for the one or more software programs, and a display unit configured to cause a display device to display an image relating to the software program activated by the activation unit. The display unit displays a screen relating to the plurality of software programs activated by the activation unit according to a display pattern corresponding to the plurality of software programs, to prevent a screen display for the software programs whose installation work is already completed from interfering with user's operation for software program newly installed by the installation unit on an initial setting screen.

Further features and aspects of the present invention are apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain principles of the invention.

FIG. 1 illustrates an example configuration of a software program installation system according to a first exemplary embodiment of the present invention.

FIG. 2 is a block diagram illustrating an example configuration of an integrated installer according to the first exemplary embodiment of the present invention.

FIG. 3 illustrates an example data structure of software information that is present in a software information holding unit according to the first exemplary embodiment of the present invention.

FIG. 4 illustrates an example dialog that prompts a user to perform initial setting for software program to be installed according to the first exemplary embodiment of the present invention.

FIG. 5 is a flowchart illustrating example processing performed by a host computer according to the first exemplary embodiment of the present invention.

FIG. 6 is a flowchart illustrating software program selection processing according to the first exemplary embodiment of the present invention.

FIG. 7 is a flowchart illustrating initial setting completion determination processing according to the first exemplary embodiment of the present invention.

FIG. 8 illustrates an example image displayed on a screen of a display device, after rebooting of the OS, according to the first exemplary embodiment of the present invention.

FIG. 9 illustrates an example image displayed on the screen of the display device, which follows the image illustrated in FIG. 8, according to the first exemplary embodiment of the present invention.

FIG. 10 illustrates an example image displayed on the screen, when initial setting for the installed software program is completed and the setting of automatic startup registration set by a user is restored, according to the first exemplary embodiment of the present invention.

FIG. 11 is a flowchart illustrating example processing performed by the host computer according to a second exemplary embodiment of the present invention.

FIG. 12 illustrates an example image displayed on the screen of the display device, after rebooting of the OS, according to the second exemplary embodiment of the present invention.

FIG. 13 illustrates an example image displayed on the screen of the display device, which follows the image illustrated in FIG. 12, according to the second exemplary embodiment of the present invention.

FIG. 14 illustrates an example image displayed on the screen, when initial setting for the installed software program is completed, according to the second exemplary embodiment of the present invention.

FIG. 15 is a flowchart illustrating example processing performed by the host computer according to a third exemplary embodiment of the present invention.

FIG. 16 illustrates an example image displayed on the screen of the display device, after rebooting of the OS, according to the third exemplary embodiment of the present invention.

FIG. 17 illustrates an example image displayed on the screen of the display device, which follows the image illustrated in FIG. 16, according to the third exemplary embodiment of the present invention.

FIG. 18 illustrates an example image displayed on the screen, when initial setting for the installed software program is completed and the setting of automatic startup registration set by a user is restored, according to the third exemplary embodiment of the present invention.

FIG. 19 illustrates an image displayed on the display device after the integrated installer installs a plurality of software programs according to an exemplary embodiment of the present invention.

### DETAILED DESCRIPTION OF THE EMBODIMENTS

The following description of exemplary embodiments is illustrative in nature and is in no way intended to limit the invention, its application, or uses. Throughout the specification, like reference numerals and letters refer to like items in the following figures, and thus, to avoid redundant description, once an item is described in one figure, it may not be discussed for other figures. Exemplary embodiments are described in detail below with reference to the drawings.

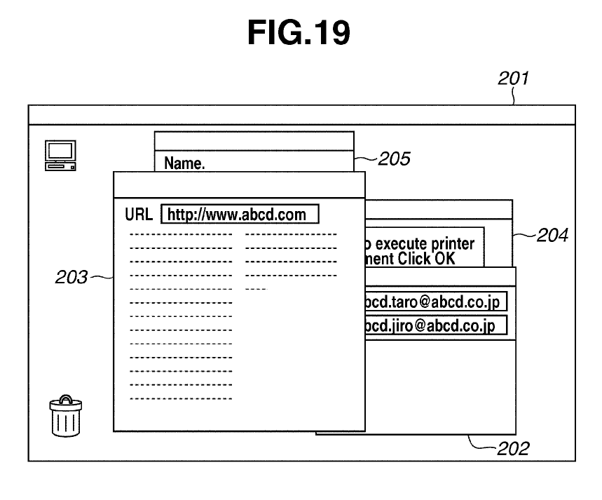

The following is a fundamental technique that relates to exemplary embodiments of the present invention. FIG. 19 illustrates an image displayed on a screen 201 of a display device after an integrated installer installs a plurality of software programs. The integrated installer simultaneously installs a plurality of software programs. Initial setting dialogs 204 and 205, i.e., dialogs that enable a user to perform initial setting, are automatically activated when the software programs are installed. To prompt the user to perform the initial setting, the initial setting dialogs 204 and 205 are simultaneously displayed upon rebooting the OS if the software programs are registered to start up automatically. Therefore, it is required to sequentially display the initial setting dialogs 204 and 205 according to the content of initial settings.

Furthermore, the example image illustrated in FIG. 19 includes a Web browser dialog 203 and a mailer software dialog 202 that are registered to start up automatically to allow the user to frequently use software programs. Accordingly, many software programs are displayed on a screen of the display device after rebooting of the OS as illustrated in FIG. 19. If the number of dialogs that require user's operation is increased, the user may become confused and forced to perform complicated operations. Accordingly, it is desirable to restrict the display of dialogs to facilitate user's operation.

According to the example image illustrated in FIG. 19, the Web browser dialog 203 is positioned at the foremost side because the Web browser dialog 203 is finally activated. In this manner, when many dialogs are displayed and the initial setting dialogs 204 and 205 are positioned behind other dialogs, the user may not notice the presence of the initial setting dialogs 204 and 205 and fail to complete the initial settings. Accordingly, it is desired to position the initial setting dialogs 204 and 205 at the fore side of the mailer software dialog 202 and the Web browser dialog 203.

According to the example illustrated in FIG. 19, four dialogs 202 to 205 are displayed simultaneously even when the sequence of initial settings is determined beforehand. A user can select an arbitrary dialog to start initial setting. Therefore, it is desired to determine the display sequence of the initial setting dialogs 204 and 205 according to the sequence of initial settings.

Furthermore, the OS allows a user to arbitrarily perform automatic startup registration. In general, computer users frequently browse Web sites on the Internet and transmit/receive e-mails. Therefore, many of computer users set the Web browser dialog 203 and the mailer software dialog 202 to start up automatically to eliminate inconvenience in manually activating the Web browser dialog 203 and the mailer software dialog 202 every time the OS is activated. If any software program whose automatic startup registration is set by the user is present, the number of dialogs to be displayed is increased. If the number of dialogs is increased, dialogs of software programs that require initial settings tend to be positioned behind other dialogs. Therefore, it is desired to position the dialogs of software programs that require initial settings at the fore side of other dialogs.

Furthermore, if the automatic startup registration function provided by the OS does not allow a user to designate the activation sequence and activation timing of software programs, the initial setting for the network or a printer is not prioritized over the initial setting for other software programs. More specifically, the dialogs enabling a user to perform initial setting for the network or a printer are concealed by the dialogs of other software programs. Thus, the OS cannot prompt a user to perform the operation according to an appropriate sequence. Therefore, it is desired to designate the activation sequence among a plurality of software programs that require initial settings.

Furthermore, when a plurality of software programs are dependent on each other, or when success/failure in setting of host software program has effects on setting of subordinate software program, or when there are some conditions to be fulfilled for the host computer environment, it is desired to dynamically provide an appropriate sequence.

For example, when there are a printing application and a printer driver, it is desired to use the printing application after the setting of the printer driver is completed and the printer is in an usable state. Furthermore, initial setting for software program may require a user to access a vendor site of the software program via the Internet and complete user registration. In this case, to perform initial setting for the software program, an Internet connection environment is required as an environment for the host computer. Accordingly, the installed software program needs to be activated after the required conditions are fulfilled. The following exemplary embodiments of the present invention can satisfy the above-described requirements.

### First Exemplary Embodiment

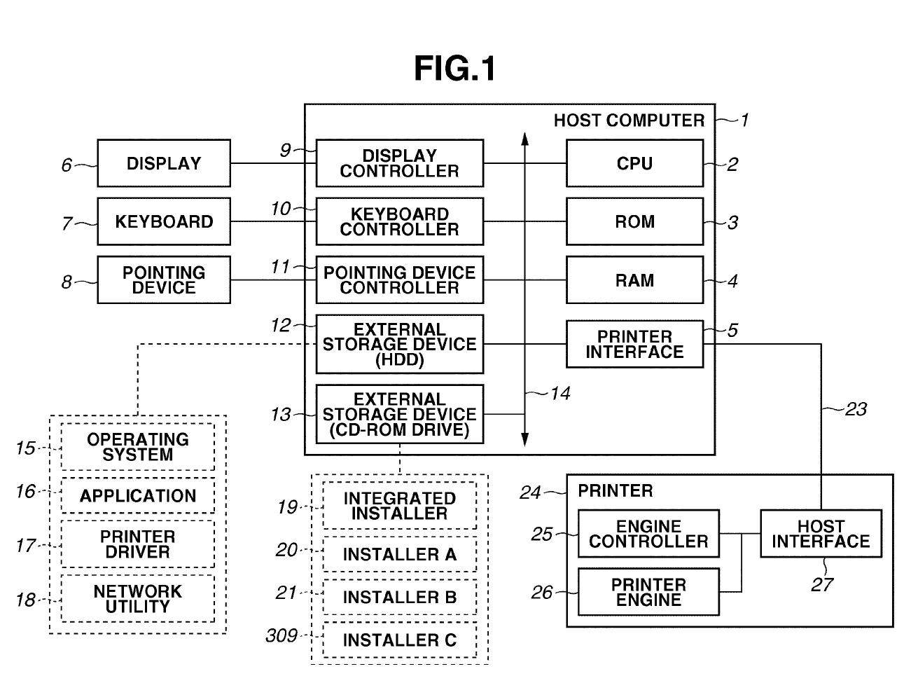

FIG. 1 illustrates an example configuration of a software program installation system according to a first exemplary embodiment of the present invention. In FIG. 1, a host computer 1 is a computer (a personal computer, a work station, etc.) that can operate as a data processing apparatus. The host computer 1 includes a central processing unit (CPU) 2. The CPU 2 executes a program stored in a read only memory (ROM) 3 when the host computer 1 starts its operation, to load an operating system (OS) 15 from an external storage device 12 into a random access memory (RAM) 4. When the CPU 2 executes the OS 15, the host computer 1 controls the system via a system bus 14.

A display device controller 9, under the control of the CPU 2, controls a display device 6 that displays various images including error warning and status of processing. A keyboard controller 10 controls a keyboard 7 that operates as an input apparatus. A pointing device controller 11 controls a pointing device 8 that operates as another input apparatus.

The external storage device (HDD) 12 stores the OS 15. An external storage device (CD-ROM drive) 13 can read data from a CD-ROM. The CD-ROM according to an exemplary embodiment stores installers 20, 21, and 309 of software programs and an integrated installer 19. The integrated installer 19 includes software program that enables the CPU 2 to execute the installers 20,21, and 309. Programs of an application 16, a printer driver 17, and a network utility 18, when installed in the host computer 1, are stored into the external storage device (HDD) 12.

The application 16 is software program that causes the host computer 1 to perform a specific work according to user operations. For example, the application 16 can edit an electronic image file. The printer driver 17 is software program that causes the host computer 1 to generate print data and commands according to which a printer 24 can perform printing. The printer driver 17 transmits the generated print data and commands to the printer 24. The network utility 18 is software program that causes the host computer 1 to use the printer 24 via a network. More specifically, the network utility 18 generates and outputs commands and parameters to a printer interface 5 and a host interface 27, which operate as Network Interface Card (NIC). Thus, the network utility 18 enables the host computer 1 and the printer 24 to perform transmission/reception of data and commands.

A cable 23 connects the printer interface 5 of the host computer 1 and the host interface 27 of the printer 24. The printer 24 includes a printer engine 26 that operates a printer head and conveys a sheet to be printed, and an engine controller 25 that interprets print data received from the host computer 1 and controls the printer engine 26.

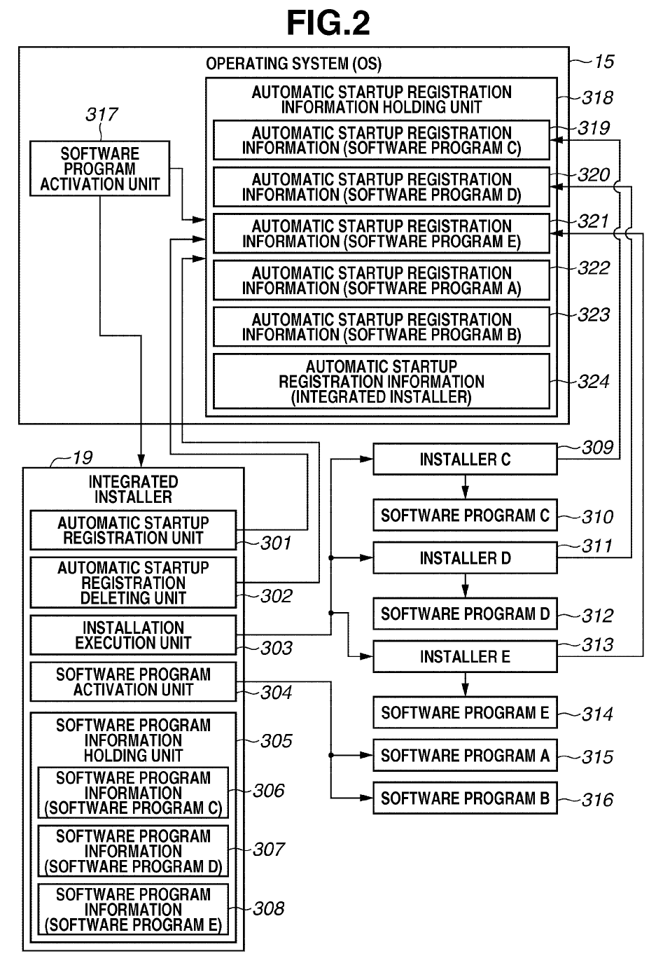

FIG. 2 is a block diagram illustrating an example configuration of the integrated installer 19. The integrated installer 19 includes an installation execution unit 303 configured to perform installation of software programs 310, 312, and 314 and a software information holding unit 305 configured to hold software-related information 306, 307, and 308. Furthermore, the integrated installer 19 includes an automatic startup registration unit 301 configured to perform automatic startup registration, an automatic startup registration deleting unit 302 configured to delete the automatic startup registration, and a software program activation unit 304 configured to activate software programs. In the following description, the software-related information is referred to as “software information.” Furthermore, the software information includes information relating to installation of software program and information relating to activation of software program.

Installers 309, 311, and 313 are programs capable of installing the software programs 310, 312, and 314. The integrated installer 19 is interactive software program that enables a user to communicate with the host computer 1. The integrated installer 19 refers to the software information holding unit 305 and causes the display device 6 to display the software information 306, 307, and 308. The user can designate software program(s) to be installed while viewing the software information 306, 307, and 308 displayed on the display device 6. The integrated installer 19 executes the installers 309, 311, and 313 that can install the software programs 310, 312, and 314 designated by a user.

When the OS 15 is activated, the OS 15 refers to automatic startup registration information 319 through 324 of the software programs stored in an automatic startup registration information holding unit 318. The OS 15 acquires automatic startup registration information of the software(s) to be activated from the automatic startup registration information holding unit 318. Then, the OS 15 causes a software activation unit 317 to successively activate the designated softwares. The OS 15 provides an interface that enables a user to add, edit, and delete automatic startup registration information.

For example, the automatic startup registration information 319 through 324 include a name of software program, an execution path, and a screen to be displayed. The “name of software program” is the name of the software program to be activated. The “execution path” is the path where the software program to be activated is present. The “screen to be displayed” indicates whether a screen belonging to the software program is displayed by the display device 6 when the software program is activated.

In the integrated installer 19, the automatic startup registration unit 301 refers to the software information holding unit 305 to perform automatic startup registration. The automatic startup registration unit 301 registers the automatic startup registration information 319 to 321 of the software programs 310, 312, and 314 into an automatic startup registration information holding unit 318 of the OS 15. The automatic startup registration deleting unit 302 refers to the automatic startup registration information holding unit 318 of the OS 15. The automatic startup registration deleting unit 302 deletes automatic startup registration of arbitrary software program from the automatic startup registration information 319 through 324. Details of the software information holding unit 305 are described later.

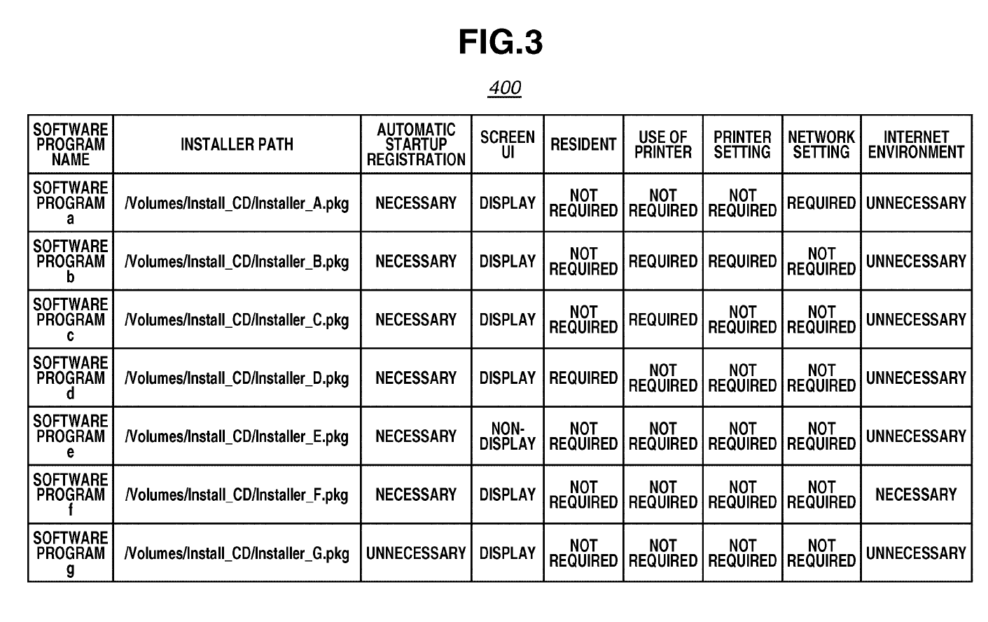

FIG. 3 illustrates an example data structure of software information that is present in the software information holding unit 305. In FIG. 3, software information 400 includes a name of software program, an installer path, and necessity of automatic startup registration. Furthermore, the software information 400 includes various initial setting information, including information indicating whether the software program displays a screen user interface (UI), information indicating whether the software program causes a printer to perform printing, and information indicating whether the software program requires connection to the Internet.

According to the example table illustrated in FIG. 3, the “network setting” value for software program “a” is “required.” For example, the software program “a” is network setting software program that enables a user to operate the printer 24 via the network. The “printer setting” value for software program “b” is “necessary.” For example, the software program “b” is software program that enables a user to adjust the printer 24 when the user uses the printer 24. The “use of printer” value for software program “c” is “required.” For example, the software program “c” is software program that performs printing of the license agreement (permission to use the software program) as initial setting. The “resident” value for software program “d” is “required.”

The software program “d” is registered to start up automatically as resident software program after completing initial settings for other software programs. The “screen UI” value for software program “e” is “non-display.” The integrated installer 19 does not delete and activate automatic startup registration of the software program “e.” The “Internet environment” value for software program “f” is “necessary.” For example, the software program “f” is software program that performs user registration via the Internet as initial setting. The “automatic startup registration” value for software program “g” is “unnecessary.” The integrated installer 19 does not perform any processing for the software program “g” after the software program “g” is installed.

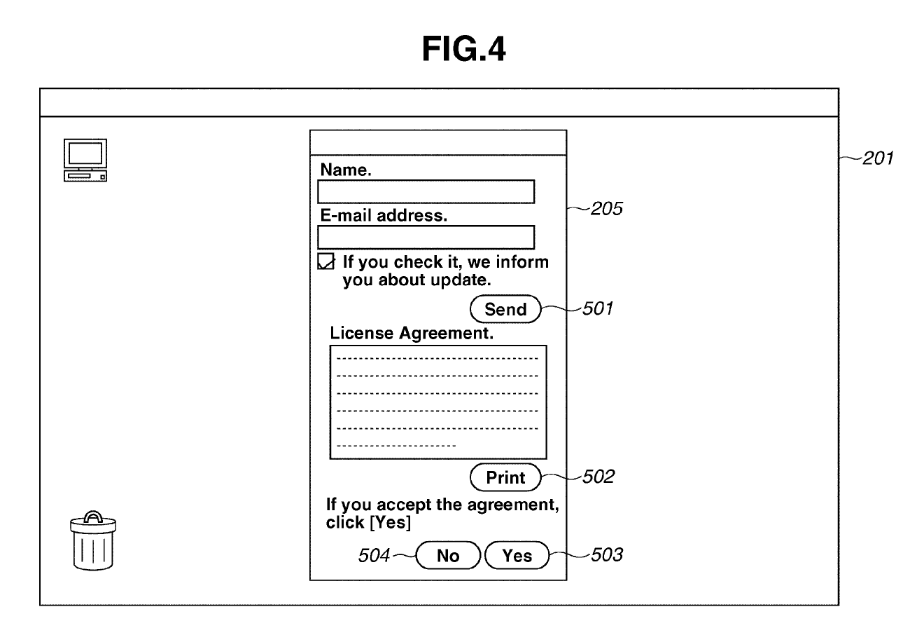

FIG. 4 illustrates an example dialog that prompts a user to perform initial settings for software program. The dialog illustrated in FIG. 4 is, for example, displayed on a screen 201 of the display device 6. According to the example illustrated in FIG. 4, the dialog 205 prompts a user to perform user registration. More specifically, the user inputs user's name and an e-mail address to respective fields on the dialog 205 and clicks on a transmission button 501. Then, the host computer 1 transmits information, via the Internet, to a server managed by a software program vendor and performs user registration. Therefore, the software program that requires initial setting performed by a user via the dialog 205 is required to transmit initial setting information via the Internet. More specifically, initial setting for the software program requires the Internet environment.

Furthermore, the screen 201 includes an area where the license agreement (permission to use the software program) is displayed. If a user accepts the license agreement and clicks on an agreement button 503, the user can use the software program. If the user does not accept the license agreement and clicks on a disagreement button 504, the user cannot use the software program. Furthermore, the dialog 205 includes a print button 502 that enables the user to print the detailed content of the license agreement. Accordingly, the software program requires the use of a printer for initial settings. It is therefore necessary that the printer is in a usable state for the initial settings of the software program. The example screen 201 illustrated in FIG. 4 includes only one dialog 205, which can facilitate input of necessary information/data by a user.

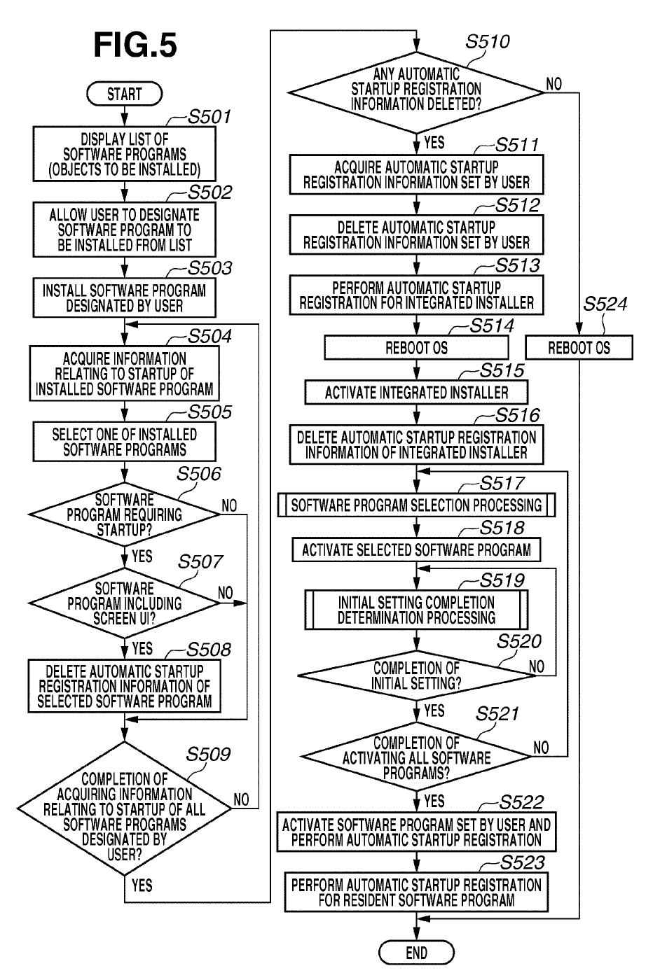

FIG. 5 is a flowchart illustrating example processing performed by the host computer 1. In step S501, the integrated installer 19 causes the display device 6 to display a list of software programs (i.e., objects to be installed). More specifically, the integrated installer 19 refers to the software information 400 stored in the software information holding unit 305 and acquires software program names. Then, the integrated installer 19 causes the display device 6 to display a list of acquired software program names.

In step S502, the integrated installer 19 allows a user to designate software program(s) to be installed with reference to the list of software programs (installation objects) displayed on the display device 6 in step S501. The pointing device 8 and the keyboard 7 enable a user to designate the software program(s). After the designation of software program(s) to be installed is completed, the processing proceeds to step S503.

When the processing proceeds to step S503, the integrated installer 19 installs the software program(s) designated by the user in step S502. More specifically, the integrated installer 19 refers to the software information 400 of the software program(s) designated by the user and acquires an installer path of the designated software program. The integrated installer 19 causes the installation execution unit 303 to activate software program installer(s) that is (are) present in the acquired installer path(s) and perform installation of the software program(s) designated by the user. The integrated installer 19 successively performs installation processing for all of the software programs designated by the user. In short, the integrated installer 19 operates as an installation unit configured to perform the above-described processing in step S503 according to an exemplary embodiment.

In step S504, the integrated installer 19 acquires, from the software information holding unit 305, software program activation information installed in step S503. The software information 400 includes the software program activation information. More specifically, the integrated installer 19 acquires the values of “automatic startup registration” and “screen UI”, as software program activation information, from the software information 400.

In step S505, the integrated installer 19 selects one of the software programs installed in step S503. In step S506, the integrated installer 19 determines whether the selected software program requires activation with reference to software program activation information selected in step S505. If the integrated installer 19 determines that the “automatic startup registration” value is “necessary” according to the software program activation information (YES in step S506), the processing proceeds to step S507. If the integrated installer 19 determines that the “automatic startup registration” value is “unnecessary” according to the software program activation information (NO in step S506), the processing proceeds to step S509.

If the software program requires activation, namely when the processing proceeds to step S507, the integrated installer 19 determines whether the software program includes a screen UI with reference to the software program activation information selected in step S505. If the integrated installer 19 determines that the “screen UI” value is “display” according to the software program activation information (YES in step S507), the processing proceeds to step S508. If the integrated installer 19 determines that the “screen UI” value is “non-display” according to the software program activation information (NO in step S507), the processing proceeds to step S509.

If the software program includes the screen UI, namely when the processing proceeds to step S508, the integrated installer 19 deletes the automatic startup registration of the software program selected in step S505. More specifically, the integrated installer 19 causes the automatic startup registration deleting unit 302 to delete the automatic startup registration information of the software program selected in step S505 from the automatic startup registration information holding unit 318 of the OS 15.

When the processing proceeds to step S509, the integrated installer 19 determines whether acquisition of activation related information is completed for all the software program(s) designated in step S502. If the integrated installer 19 determines that acquisition of activation related information is not completed for all the software program(s) designated in step S502 (NO in step S509), the processing returns to step S504. The integrated installer 19 repetitively performs the processing of steps S504 through S509. If the integrated installer 19 determines that acquisition of activation related information is completed for all the software program(s) designated in step S502 (YES in step S509), the processing proceeds to step S510.

When the processing proceeds to step S510, the integrated installer 19 determines whether the above-described processing has deleted the automatic startup registration information. More specifically, the integrated installer 19 determines whether the processing of step S508 has been executed. If in step S510 the integrated installer 19 determines that the above-described processing has not deleted any automatic startup registration information, i.e., when the integrated installer 19 has not executed the processing of step S508, the processing proceeds to step S524. If in step S510 the integrated installer 19 determines that the above-described processing has deleted the automatic startup registration information, i.e., when the integrated installer 19 has executed the processing of step S508, the processing proceeds to step S511.

When the processing proceeds to step S511, the integrated installer 19 acquires, from the OS 15, automatic startup registration information currently set by a user. More specifically, the integrated installer 19 refers to the automatic startup registration information holding unit 318 of the OS 15 and acquires information relating to “software program name”, “execution path”, and “screen to be displayed.”

In step S512, the integrated installer 19 deletes all the automatic startup registration information having been set beforehand by the user to prevent the software program from being activated in response to rebooting of the OS 15. The integrated installer 19 causes the automatic startup registration deleting unit 302 to refer to the automatic startup registration information holding unit 318 of the OS 15 and delete all the automatic startup registration information having been set by the user.

The example configuration illustrated in FIG. 2 includes software programs 315 and 316 whose automatic startup registration is already set by a user. The software programs 315 and 316 are in a usable state when installed in the host computer 1. Accordingly, the integrated installer 19 deletes all the automatic startup registration information 322 and 323 of the software programs 315 and 316. In short, the integrated installer 19 operates as a canceling unit configured to delete the automatic startup registration information (i.e., the above-described processing in step S512) according to an exemplary embodiment.

In step S513, the integrated installer 19 performs automatic startup registration for the integrated installer 19 itself so that the integrated installer 19 can automatically start up after rebooting the OS 15. More specifically, the integrated installer 19 causes the automatic startup registration unit 301 to register automatic startup registration information of the integrated installer 19 into the automatic startup registration information holding unit 318 of the OS 15. According to the example illustrated in FIG. 2, the automatic startup registration information holding unit 318 of the OS 15 stores automatic startup registration information 324 of the integrated installer 19.

In step S514, the integrated installer 19 performs rebooting of the OS 15. In step S515, after rebooting of the OS 15, the software program activation unit 317 activates the integrated installer 19 (automatic startup registration which has been performed in step S513).

In step S516, the integrated installer 19 deletes the automatic startup registration information of the integrated installer 19 to prevent the integrated installer 19 from being activated in response to rebooting of the OS 15. More specifically, the integrated installer 19 refers to the automatic startup registration information holding unit 318 of the OS 15 and deletes the automatic startup registration information 324 of the integrated installer 19.

In step S517, the integrated installer 19 performs software program selection processing for selecting software program to be activated. The sequence of software programs to be activated is variable depending on various conditions. Therefore, by executing the selection processing of step S517, the integrated installer 19 selects the software program to be activated. The software program selection processing performed by the integrated installer 19 is described later. In short, the integrated installer 19 operates as a selection unit configured to perform the processing of step S517 according to an exemplary embodiment.

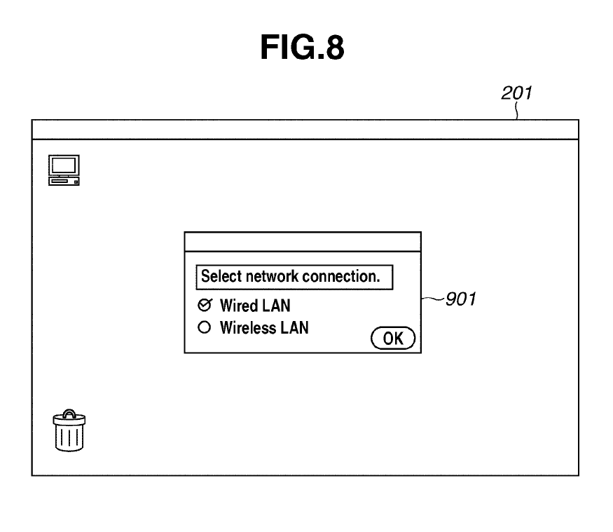

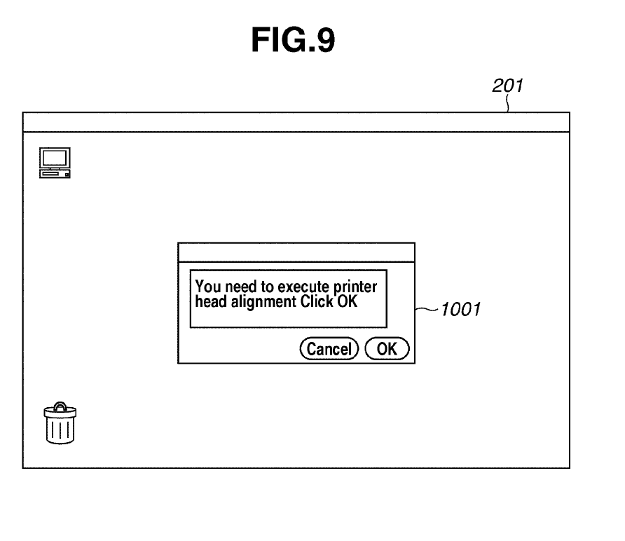

In step S518, the integrated installer 19 activates the software program selected in step S517. More specifically, the integrated installer 19 activates the software program output (returned) by the software program selection processing in step S517. In step S518, after the software program selected in step S517 is activated, the integrated installer 19 causes the display device 6 to display initial setting dialogs 901 and 1001 for the software program (refer to FIGS. 8 and 9). In short, the integrated installer 19 operates as an activation unit and a display unit configured to perform the processing of step S518 according to an exemplary embodiment.

In step S519, the integrated installer 19 performs initial setting completion determination processing for the software program activated in step S518. More specifically, to successively activate the software programs, if the integrated installer 19 determines that initial setting for the software program has been completed, the processing proceeds to the next step. The method for determining the completion of the initial setting for the software program is variable depending on the type of the software program. The initial setting completion determination processing for the software program performed by the integrated installer 19 is described later. In short, the integrated installer 19 operates as an initial setting completion determination unit configured to perform the processing of step S519 according to an exemplary embodiment.

When the processing proceeds to step S520, the integrated installer 19 determines whether the initial setting for the software program has been completed based on the result of the initial setting completion determination processing performed in step S519. If the integrated installer 19 determines that the initial setting for the software program is not completed (NO in step S520), the processing returns to step S519 to repetitively perform the processing of steps S519 and S520. If the integrated installer 19 determines that the initial setting for the software program is completed (YES in step S520), the processing proceeds to step S521.

When the processing proceeds to step S521, the integrated installer 19 determines whether activation of all the software programs has been completed. If the integrated installer 19 determines that activation of all the software programs is not completed (NO in step S521), the processing returns to step S517 to repetitively perform the processing of steps S517 through S521. If the integrated installer 19 determines that activation of all the software programs is completed (YES in step S521), the processing proceeds to step S522.

When the processing proceeds to step S522, the integrated installer 19 refers to “automatic startup registration information set by the user” acquired in step S511 and activates the software program whose automatic startup registration is set by the user. Furthermore, the integrated installer 19 causes the automatic startup registration unit 301 to re-store the “automatic startup registration information set by the user” deleted in step S514 into the automatic startup registration information holding unit 318.

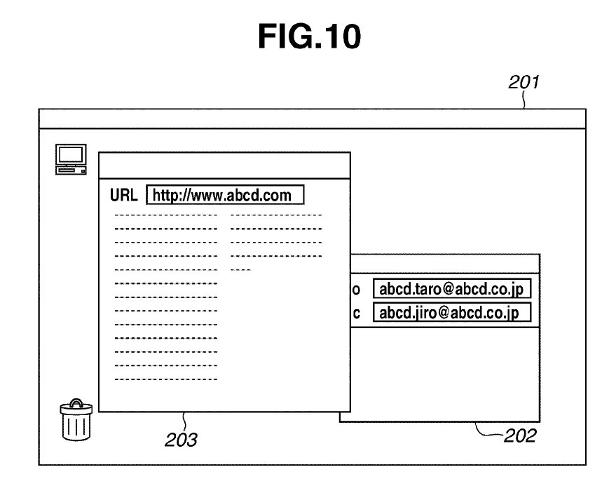

More specifically, the integrated installer 19 performs automatic startup registration again for the automatic startup registration information set by the user and restores the automatic startup registration information set by the user. In step S522, after the software program registered to start up automatically by the user is activated, the integrated installer 19 causes the display device 6 to display the Web browser dialog 203 and the mailer software dialog 202 for the software program (FIG. 10). In short, the integrated installer 19 operates as an activation unit and a display unit configured to perform the processing of step S522 according to an exemplary embodiment. Furthermore, the integrated installer 19 operates as a resetting unit configured to perform the processing of step S522 to re-register automatic startup registration information.

In step S523, the integrated installer 19 performs automatic startup registration for resident software program(s) having been installed. More specifically, the integrated installer 19 refers to the software information 400 of the installed software program and causes the automatic startup registration unit 301 to store automatic startup registration information of the software program, whose “resident” value is “required”, into the automatic startup registration information holding unit 318. Then, the integrated installer 19 terminates the processing of the routine illustrated in FIG. 5. In short, the integrated installer 19 operates as a setting unit configured to perform the processing of step S523 according to an exemplary embodiment.

If in step S510 the integrated installer 19 determines that the above-described processing has not deleted the automatic startup registration information, i.e., when the integrated installer 19 has not executed the processing of step S508, the processing proceeds to step S524. When the processing proceeds to step S524, the integrated installer 19 performs rebooting of the OS 15. After rebooting of the OS 15, the integrated installer 19 terminates the processing of the routine illustrated in FIG. 5. In this manner, the integrated installer 19 can complete the installation work according to the flowchart illustrated in FIG. 5.

As described above, when a user uses the integrated installer 19 to install a plurality of software programs, an exemplary embodiment prevents software program(s) present in the automatic startup registration information set beforehand by a user from being displayed on a screen. Then, after successively executing initial setting for the software program to be installed, the exemplary embodiment restores (re-registers) the automatic startup registration information having been set beforehand by the user.

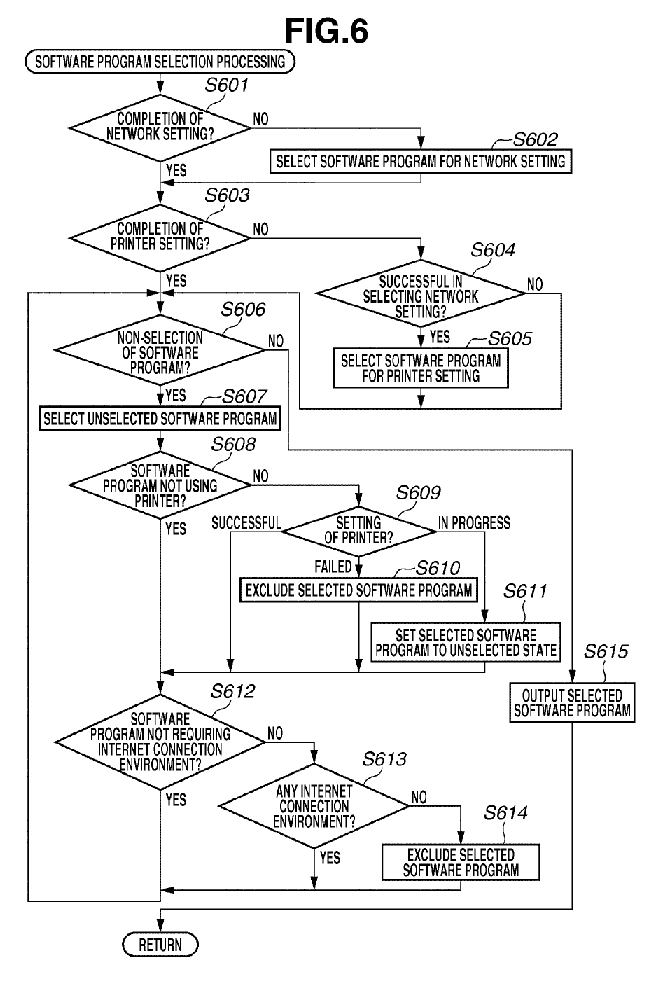

FIG. 6 is a flowchart illustrating software program selection processing performed in step S517 illustrated in FIG. 5. The software program selection processing according to an exemplary embodiment classifies the software programs into three types. The first type is a printer driver that communicates with the printer 24 and transmits a print command and an adjustment command to the printer 24. The second type is network setting software program that enables a user to perform setting of the network when the printer 24 is used in the network environment. The third type is miscellaneous software programs including printing application software programs. The printing software program requires a printer driver that performs printing. To use a printer driver via the network, network setting software program is necessary. Thus, the processing of three types of software programs is prioritized in the order of network setting software program, printer driver, and miscellaneous software programs.

In step S601, the integrated installer 19 determines whether setting of the network has been completed by the network setting software program. When the software program selection processing is executed for the first time, or when the setting of the network is incomplete (NO in step S601), the processing proceeds to step S602. If the integrated installer 19 determines that the setting of the network has been completed by the network setting software program (YES in step S601), the processing skips step S602 and proceeds to step S603.

When the processing proceeds to step S602, the integrated installer 19 selects network setting software program. When the processing proceeds to step S603, the integrated installer 19 determines whether the setting of the printer 24 has been completed by the printer setting software program. If the integrated installer 19 determines that the setting of the printer 24 has not been completed (NO in step S603), the processing proceeds to step S604. If the integrated installer 19 determines that the setting of the printer 24 is already completed (YES in step S603), the processing skips steps S604 and S605 and proceeds to step S606.

When the processing proceeds to step S604, the integrated installer 19 determines whether the setting of the network by the network setting software program is successful. If the integrated installer 19 determines that the setting of the network is successful (YES in step S604), the processing proceeds to step S605. If the integrated installer 19 determines that the setting of the network has failed (NO in step S604), the host computer 1 cannot communicate with the printer 24. Therefore, no initial setting is required for the printer 24. The processing skips step S605 and proceeds to step S606. If the host computer 1 cannot access the network, or when the setting of the network is interrupted, the integrated installer 19 determines that the setting of the network has failed.

When the processing proceeds to step S605, the integrated installer 19 selects printer setting software program. When the processing proceeds to step S606, the integrated installer 19 determines whether the software program is not selected at this moment. When the processing has executed step S602 or step S605, the integrated installer 19 determines that the processing has selected the software program. When the selection of software program is performed in step S607 or in the following step, the integrated installer 19 determines that the processing has selected the software program.

If the integrated installer 19 determines that the software program is selected (NO in step S606), the processing proceeds to step S615. Then, the integrated installer 19 outputs the selected software program and terminates the processing of the routine illustrated in FIG. 6. If the integrated installer 19 determines that no software program is selected (YES in step S606), the processing proceeds to step S607.

When the processing proceeds to step S607, the integrated installer 19 selects one of the unselected software programs. In determining the software program to be selected among the unselected software programs in step S607, the integrated installer 19 prioritizes the software program that is not excluded in step S610 or step S614.

In step S608, the integrated installer 19 determines whether the software program selected in step S607 is software program that does not use the printer 24. The integrated installer 19 can perform the determination of step S608 based on the “use of printer” value of the software information 400. When the “use of printer” value is “required”, the integrated installer 19 determines that the software program selected in step S607 is software program that uses the printer 24. Then, the processing proceeds to step S609. When the “use of printer” value is “not required”, the integrated installer 19 determines that the software program selected in step S607 is software program that does not use the printer 24. Then, the processing proceeds to step S612.

If the software program selected in step S607 is software program that uses the printer 24, i.e., when the processing proceeds to step S609, the integrated installer 19 identifies the current setting of the printer 24. When the setting of the printer 24 is performed, the printer setting software program issues an adjustment command for the printer 24. If in step S609 the integrated installer 19 determines that the setting of the printer 24 is already completed (when the setting of the printer 24 is successful), the processing proceeds to step S612. For example, when the printer 24 is in a usable state and can communicate with the host computer 1, the integrated installer 19 determines that the setting of the printer 24 is already completed (determines that the setting of the printer 24 is successful).

If the setting of the printer 24 is not executed or incomplete (when the setting of the printer 24 has failed), the processing proceeds to step S610. The printer 24 starts its operation in response to reception of an adjustment command and performs the adjustment. When the adjustment command is issued, the integrated installer 19 determines in step S609 that the setting of the printer 24 is in progress (i.e., the setting of the printer 24 is in progress). Then, the processing proceeds to step S611.

If the setting of the printer 24 has failed, i.e., when the processing proceeds to step S610, the integrated installer 19 excludes the software program selected in step S607 (or changes the status of the software program selected in step S607 into “unselected”). If the setting of the printer 24 is in progress, i.e., when the processing proceeds to step S611, the integrated installer 19 sets the software program selected in step S607 to an unselected state.

When the processing proceeds to step S612, the integrated installer 19 determines whether the software program selected in step S607 is software program that requires the Internet connection environment. The integrated installer 19 can make the determination with reference to the “Internet environment” value in the software information 400. If the “Internet environment” value for the software program is “unnecessary”, the integrated installer 19 determines that the software program selected in step S607 is not the software program that requires the Internet connection environment. Then, the processing returns to step S606.

If the “Internet environment” value for the software program is “necessary”, the integrated installer 19 determines that the software program selected in step S607 is the software program that requires the Internet connection environment. Then, the processing proceeds to step S613. When the processing proceeds to step S613, the integrated installer 19 determines whether there is any Internet connection environment. If the integrated installer 19 determines that the Internet connection environment is present (YES in step S613), the processing returns to step S606. If the integrated installer 19 determines that the Internet connection environment is not present (NO in step S613), the processing proceeds to step S614.

When the processing proceeds to step S614, the integrated installer 19 excludes the software program selected in step S607 (or changes the status of the software program selected in step S607 into “unselected”). If the host computer has no Internet environment, the integrated installer 19 sets the selected software program to “unselected.”

As described above, in step S615, the integrated installer 19 outputs the selected software program as an object to be activated and terminates the processing of the routine illustrated in FIG. 6. As described above, an exemplary embodiment can select software program that is optimum for performing initial setting processing. Furthermore, as the conditions to be fulfilled for performing initial setting, an exemplary embodiment determines whether the setting of the network has been completed, whether the setting of the printer has been completed, whether the setting of the printer 24 is successful, and whether the Internet connection environment is present. If these conditions are fulfilled, the software programs selected in steps S602, S605, and S607 are activated in step S518.

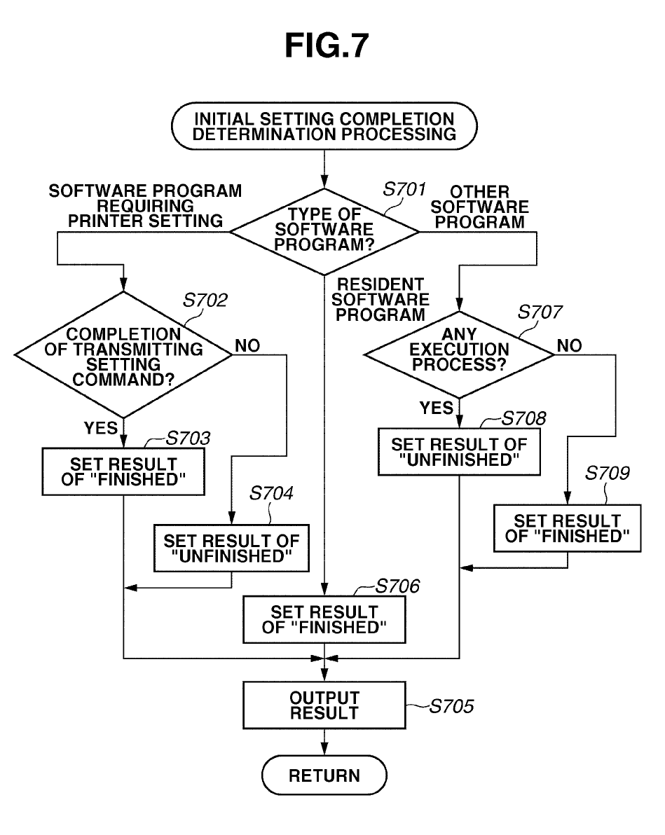

FIG. 7 is a flowchart illustrating initial setting completion determination processing performed in step S519 illustrated in FIG. 6. The processing for determining the completion of the initial setting can be switched according to the type of software program. The integrated installer 19 can output (return) “finished” or “unfinished” as the result of the initial setting completion determination processing.

In step S701, the integrated installer 19 identifies the type of software program. More specifically, the integrated installer 19 refers to the software information 400 of the software program selected in step S517 and identifies the type of the software program. If the “printer setting” value is “required”, the processing proceeds to step S702. If the “resident” value is “required”, the processing proceeds to step S706. In other cases, the processing proceeds to step S707.

When the processing proceeds to step S702, the integrated installer 19 determines whether the printer setting software program has transmitted a setting command to the printer 24. If the integrated installer 19 determines that the setting command has been already transmitted to the printer 24 (YES in step S702), the processing proceeds to step S703. If the integrated installer 19 determines that the setting command has not been transmitted to the printer 24 (NO in step S702), the processing proceeds to step S704.

When the processing proceeds to step S703, i.e., when the setting command of the printer setting software program has been already transmitted, the integrated installer 19 sets “finished” as the result of the initial setting completion determination processing. When the processing proceeds to step S704, i.e., when the setting command of the printer setting software program has not been transmitted, the integrated installer 19 sets “unfinished” as the result of the initial setting completion determination processing. When the processing proceeds to step S705, the integrated installer 19 outputs (returns) the result set in step S703 or S704.

If in step S701 the integrated installer 19 determines that the “resident” value is “required”, the processing proceeds to step S706. In step S706, the integrated installer 19 sets “finished” as the result of the initial setting completion determination processing. The resident software program does not require completion of the software program. Therefore, the integrated installer 19 sets “finished” as the result of the initial setting completion determination processing. When the processing proceeds to step S705, the integrated installer 19 outputs (returns) the result set in step S706.

In step S701, if the integrated installer 19 determines that both the “printer setting” value and the “resident” value are not “required”, the processing proceeds to step S707. When the processing proceeds to step S707, the integrated installer 19 determines whether there is any execution process for the activated software program. If the integrated installer 19 determines that the execution process is present (YES in step S707), the processing proceeds to step S708. If the integrated installer 19 determines that the execution process is not present (NO in step S707), the processing proceeds to step S709.

When the processing proceeds to step S708, i.e., when an execution process for the activated software program is present, the integrated installer 19 sets “unfinished” as the result of the initial setting completion determination processing. When the processing proceeds to step S709, i.e., when the execution process for the activated software program is not present, the integrated installer 19 sets “finished” as the result of the initial setting completion determination processing. After performing step S708 or S709, processing proceeds to step S705, wherein the integrated installer 19 outputs (returns) the result set. As described above, an exemplary embodiment can appropriately perform completion processing for the software program that performs initial setting processing according to the type of the software program.

FIGS. 8 through 10 illustrate example screens displayed on the display device 6 when the integrated installer 19 is used. The example screens illustrated in FIGS. 8 through 10 are sequentially displayed on the display device 6 when the integrated installer 19 is used to install software programs. The display device 6 changes the screen 201 according to the sequence of FIGS. 8 through 10. It is now assumed that automatic startup registration for the Web browser dialog 203 and the mailer software dialog 202 illustrated in FIG. 19 is already set by a user. It is now also assumed that the installed software programs include network setting software program and printer setting software program.

FIG. 8 illustrates an example image displayed on the screen 201 of the display device 6 after rebooting of the OS 15. More specifically, the screen 201 displays the initial setting dialog 901 for the network setting software program initially selected by the software program selection processing in step S517 illustrated in FIG. 5. The software program having been set for automatic startup registration by the integrated installer 19 at this moment does not include printer setting software program, miscellaneous software programs, and software programs set by the user beforehand. Accordingly, only the network setting software program is displayed on the display device 6.

FIG. 9 illustrates an example image displayed on the screen 201 of the display device 6, which follows the image illustrated in FIG. 8. According to the example image illustrated in FIG. 9, the screen 201 displays the initial setting dialog 1001 of the printer setting software program. The software program having been set for automatic startup registration by the integrated installer 19 at this moment does not include network setting software program, miscellaneous software programs, and software programs set by the user beforehand. Accordingly, only the initial setting dialog 1001 of the printer setting software program is displayed on the display device 6. Furthermore, as the setting for a network setting printer is already finished, the setting of the printer can be performed successfully.

FIG. 10 illustrates an example image displayed on the screen 201 when the initial setting for the installed software program is finished and the setting for the automatic startup registration having been set by the user beforehand is restored. After completing the installation of the software program, the integrated installer 19 activates the Web browser dialog 203 and the mailer software dialog 202 whose automatic startup registration has been set beforehand (step S522).

Furthermore, the integrated installer 19 performs automatic startup registration for the Web browser dialog 203 and the mailer software dialog 202 (step S522). Thus, the setting of the automatic startup registration having been set by the user can be restored. As described above, according to an exemplary embodiment, the initial setting dialogs 901 and 1001 can realize initial setting screens for newly installed software programs. Furthermore, the Web browser dialog 203 and the mailer software dialog 202 realize the screen for the software programs whose installation work is already completed.

As described above, the integrated installer 19 according to an exemplary embodiment installs a plurality of software programs based on user's instruction and deletes the automatic startup registration information that is set by a user beforehand. Then, the integrated installer 19 causes the display device 6 to display the initial setting dialogs 901 and 1001 of the installed software programs, when the installed software programs are activated, according to the sequence based on “information relating to initial setting contents” involved in these software programs. Then, after successive execution of initial settings based on user's operations via the initial setting dialogs 901 and 1001, the integrated installer 19 activates the software program(s) whose automatic startup registration is set by the user beforehand and restores the automatic startup registration information of the software program.

Accordingly, an exemplary embodiment enables a user to execute the initial settings in an appropriate sequence while viewing dialogs successively displayed on the display unit. Therefore, the exemplary embodiment can provide excellent operability for the users. More specifically, the exemplary embodiment prevents the Web browser dialog 203 and the mailer software dialog 202 from interfering with the user's operation on the initial setting dialogs 901 and 1001. Furthermore, when a dialog of the newly installed software program is displayed, the exemplary embodiment does not display the dialog of the software program whose automatic startup registration is set beforehand by a user. Therefore, the exemplary embodiment can provide excellent operability for the users.

According to the above-described exemplary embodiment, the integrated installer 19 installs a plurality of software programs. However, the number of software programs to be installed by the integrated installer 19 may alternatively be only one. In this case, the system controls the display sequence between the dialog of the software program to be installed and the dialog of the software program whose automatic startup registration is set beforehand by a user. For example, the system displays the dialog of the software program to be installed based on the presence of automatic startup setting information of the software program. Then, the system displays the dialog of the software program whose automatic startup registration is set beforehand by a user. Furthermore, according to the above-described exemplary embodiment, the system controls only the display sequence. However, as another display pattern of dialog(s), the system can alternatively control at least one of the display position and the display area (size, range, etc.) in addition to the display sequence.

### Second Exemplary Embodiment

A second exemplary embodiment of the present invention is described below. The above-described first exemplary embodiment once deletes automatic startup registration information having been set beforehand by a user. The second exemplary embodiment differs from the first exemplary embodiment in that automatic startup registration information having been set beforehand by the user is not deleted. The second exemplary embodiment also differs from the first exemplary embodiment in part of the processing illustrated in FIG. 5.

More specifically, the host computer 1 and the printer 24 according to the second exemplary embodiment are similar in hardware configuration to those illustrated in FIG. 1. The software configuration for the host computer 1 according to the second exemplary embodiment is similar to that illustrated in FIG. 2. The software information 400 according to the second exemplary embodiment is similar to the example illustrated in FIG. 3. Furthermore, the second exemplary embodiment performs software program selection processing similar to that illustrated in FIG. 6 and performs initial setting completion determination processing similar to that illustrated in FIG. 7. Accordingly, reference numerals used in FIGS. 1 through 10 and 19 for the first exemplary embodiment are attached to similar portions in the description of the second exemplary embodiment. The differences between the first and second exemplary embodiments are further described below.

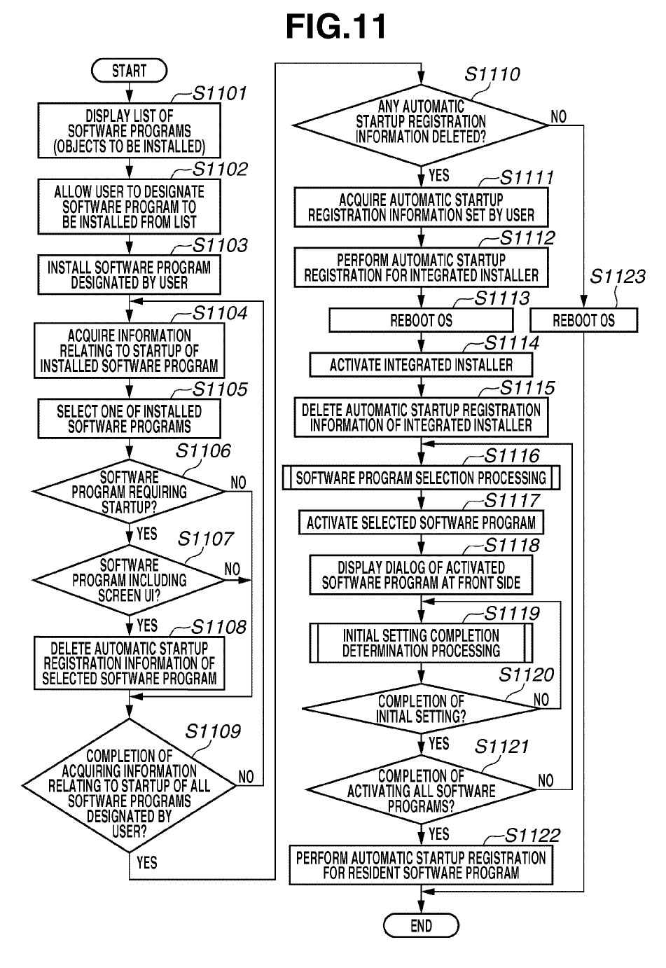

FIG. 11 is a flowchart illustrating example processing performed by the host computer 1.

Processing performed in steps S1101 through S1117 is similar to the processing in steps S501 through S511 and steps S513 through S518 illustrated in FIG. 5. In step S1101, the integrated installer 19 causes the display device 6 to display a list of software programs (objects to be installed). In step S1102, the integrated installer 19 allows a user to designate software program(s) to be installed with reference to the list of software programs (installation objects) displayed on the display device 6.

In step S1103, the integrated installer 19 installs the software program(s) designated by the user. In step S1104, the integrated installer 19 acquires software program activation information installed in step S1103 from the software information holding unit 305. As described above, the “automatic startup registration” value and the “screen UI” value are the information relating to activation.

In step S1105, the integrated installer 19 selects one of the installed software programs. In step S1106, the integrated installer 19 determines whether the selected software program requires activation based on the selected software program activation information.

If the software program requires activation (YES in step S1106), the processing proceeds to step S1107. In step S1107, the integrated installer 19 determines whether the software program includes a screen UI with reference to the software program activation information selected in step S1105. If the integrated installer 19 determines that the software program selected in step S1105 includes the screen UI (YES in step S1107), the processing proceeds to step S1108. In step S1108, the integrated installer 19 deletes automatic startup registration information of the selected software program. Then, the processing proceeds to step S1109. If the integrated installer 19 determines that the selected software program does not require activation (NO in step S1106) or if the integrated installer 19 determines that the selected software program does not include any screen UI (NO in step S1107), the processing proceeds to step S1109.

When the processing proceeds to step S1109, the integrated installer 19 determines whether acquisition of activation related information is completed for all the software program(s) designated in step S1102. If the integrated installer 19 determines that acquisition of activation related information is not completed for all the designated software program(s) (NO in step S1109), the processing returns to step S1104. The integrated installer 19 repetitively performs the processing of steps S1104 through S1109. If the integrated installer 19 determines that acquisition of activation related information is completed for all the designated software program(s) (YES in step S1109), the processing proceeds to step S1110. In step S1110, the integrated installer 19 determines whether the processing of step S1108 has been executed.

If the integrated installer 19 has not executed the processing of step S1108 (NO in step S1110), the processing proceeds to step S1123. In step S1123, the integrated installer 19 performs rebooting of the OS 15 and terminates the processing of the routine illustrated in FIG. 11. If the integrated installer 19 has executed the processing of step S1108 (YES in step S1110), the processing proceeds to step S1111. In step S1111, the integrated installer 19 acquires, from the OS 15, the automatic startup registration information currently set by the user. As described above, the integrated installer 19 acquires information relating to “software program name”, “execution path”, and “screen to be displayed” as automatic startup registration information.

In step S1112, the integrated installer 19 performs automatic startup registration for the integrated installer 19 itself so that the integrated installer 19 can automatically start up after rebooting of the OS 15. In this manner, the second exemplary embodiment does not execute processing corresponding to step S512 of FIG. 5 (i.e., the processing for deleting the automatic startup registration information set by the user).

In step S1113, the integrated installer 19 performs rebooting of the OS 15. In step S1114, the software program activation unit 317 activates the integrated installer 19 (automatic startup registration which has been performed in step S1112). In step S1115, the integrated installer 19 deletes the automatic startup registration information of the integrated installer 19 to prevent the integrated installer 19 from being activated in response to rebooting of the OS 15.

In step S1116, the integrated installer 19 performs software program selection processing for selecting software program to be activated. In step S1117, the integrated installer 19 activates the software program selected by the software program selection processing. In the exemplary embodiment, any software program whose automatic startup registration is set by a user can be subjected to the selection processing in step S1116. However, the timing for activating the registered software program is not limited to the above-described step. For example, similar to the first exemplary embodiment, the exemplary embodiment can activate the software program whose automatic startup registration is set by the user, after the initial setting for the newly installed software program is finished.

In step S1118, the integrated installer 19 causes the display device 6 to display a dialog of the software program activated in step S1117 at the fore side (desirably, at the foremost side) on the screen 201. Windows®, as an example of the OS 15, includes an interface that controls the position of each dialog window on the display device 6. The integrated installer 19 transfers a desired position of the dialog on the desktop screen (i.e., the screen 201), via the interface, to the dialog window of the software program, as argument, and controls the position of the dialog. The integrated installer 19 positions the dialog window of the software program activated in step S1117 at the foremost side of the desktop screen.

Windows®, as an example of the OS 15, provides a function of “minimizing” the dialog window, according to which an icon indicating the minimized dialog window is displayed on a tool bar. Accordingly, when the OS 15 is Windows®, the integrated installer 19 can position the dialog of the activated software program at the foremost side by minimizing other dialogs in the processing of step S1118. As described above, an exemplary embodiment can provide a display unit configured to perform the processing of step S1118.

In steps S1119 through S1122, the integrated installer 19 performs processing similar to the processing in steps S519 through S521 and S523 illustrated in FIG. 5. In step S1119, the integrated installer 19 performs initial setting completion determination processing for the software program activated in step S1117. In step S1120, the integrated installer 19 determines whether the initial setting for the software program has been finished based on the result of the initial setting completion determination processing. The integrated installer 19 repetitively performs the processing of steps S1119 and S1120.

When the integrated installer 19 determines that the initial setting for the software program activated in step S1117 is finished (YES in step S1120), the processing proceeds to step S1121. In step S1121, the integrated installer 19 determines whether activation of all the software programs has been completed. If the integrated installer 19 determines that activation of all the software programs is not completed (NO in step S1121), the processing returns to step S1116 to repetitively perform the processing of steps S1116 through S1121. If the integrated installer 19 determines that activation of all the software programs is completed (YES in step S1121), the processing proceeds to step S1122.

In step S1122, the integrated installer 19 performs automatic startup registration for resident software program(s) having been installed. Then, the integrated installer 19 terminates the processing of the routine illustrated in FIG. 11. As described above, an exemplary embodiment does not perform the processing for deleting the automatic startup registration information having been set by a user (processing performed in step S512 of FIG. 5). Accordingly, the exemplary embodiment does not provide a step corresponding to step S522 of FIG. 5 between steps S1121 and S1122.

As described above, the integrated installer 19 according to an exemplary embodiment enables a user to install a plurality of software programs, displays a dialog of each software program at the foremost side when initial setting for the software program is activated, and successively executes initial setting for all software programs to be installed.

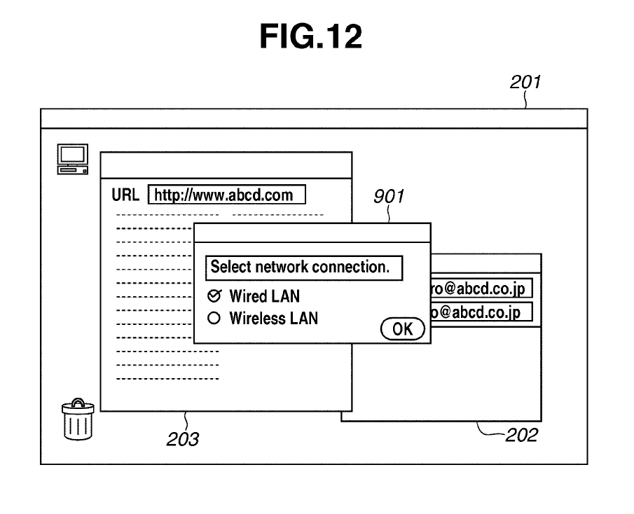

FIGS. 12 through 14 illustrate example screens displayed on the display device 6 when the integrated installer 19 is used. Similar to the example screens illustrated in FIGS. 8 through 10, the example screens illustrated in FIGS. 12 through 14 are sequentially displayed on the display device 6 when the integrated installer 19 is used to install software programs. It is now assumed that automatic startup registration for the Web browser dialog 203 and the mailer software dialog 202 illustrated in FIG. 19 is already set by a user. And, the installed software programs include network setting software program and printer setting software program.

FIG. 12 illustrates an example image displayed on the screen 201 of the display device 6 after rebooting of the OS 15. More specifically, the screen 201 displays, at the foremost side of the screen 201, the initial setting dialog 901 for the network setting software program initially selected by the software program selection processing in step S1116 illustrated in FIG. 11. The software program having been set for automatic startup registration by the integrated installer 19 at this moment does not include printer setting software program and miscellaneous software programs.

However, automatic startup registration for the software programs set by the user beforehand is not deleted at this moment. Therefore, the Web browser dialog 203 and the mailer software dialog 202 are displayed behind the initial setting dialog 901 of the network setting software program. The integrated installer 19 causes the display device 6 to display the initial setting dialog 901 of the network setting software program at the foremost side of the screen 201, by the processing in step S1118. Thus, both the Web browser dialog 203 and the mailer software dialog 202 are positioned behind the initial setting dialog 901 of the network setting software program. Accordingly, the user can recognize the prioritized display of the initial setting dialog 901 of the network setting software program and is prompted to operate the initial setting dialog 901 of the network setting software program.

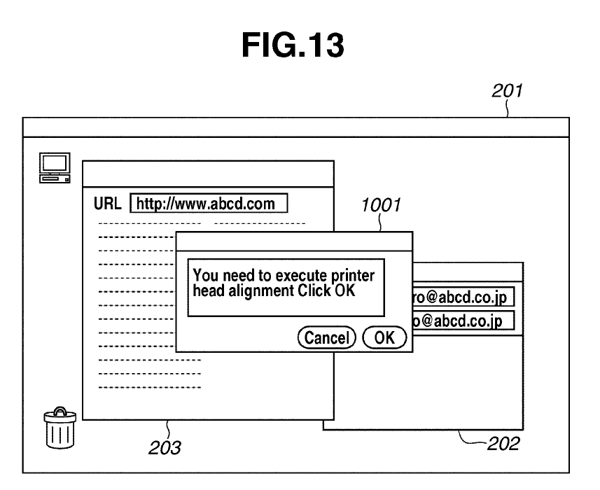

FIG. 13 illustrates an example image displayed on the screen 201 of the display device 6, which follows the image illustrated in FIG. 12. According to the example image illustrated in FIG. 13, the screen 201 displays the initial setting dialog 1001 of the printer setting software program. More specifically, the integrated installer 19 causes the display device 6 to display the initial setting dialog 1001 of the printer setting software program at the foremost side of the screen 201. Thus, both the Web browser dialog 203 and the mailer software dialog 202 are positioned behind the initial setting dialog 1001 of the printer setting software program. Accordingly, the user can recognize the display of the initial setting dialog 1001 of the printer setting software program prioritized over other displays and is prompted to operate the initial setting dialog 1001 of the printer setting software program. Furthermore, as the setting for a network setting printer is already finished, the setting of the printer can be performed successfully.

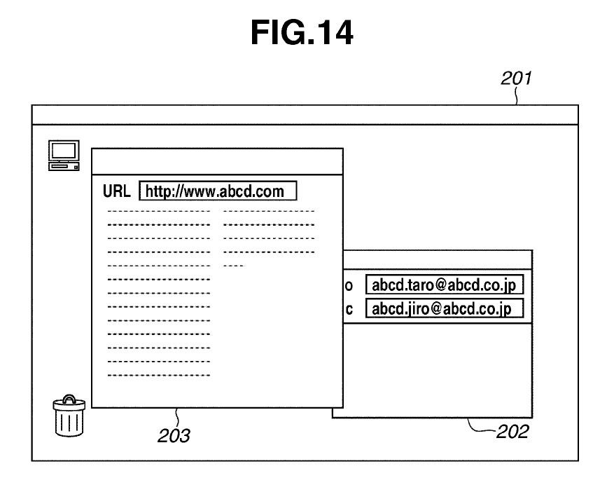

FIG. 14 illustrates an example image displayed on the screen 201 when the initial setting for the install software program(s) is finished. The Web browser dialog 203 or the mailer software dialog 202 is displayed at the fore side of the screen 201 after completing the initial setting using the initial setting dialog 901 of the network setting software program and the initial setting dialog 1001 of the printer setting software program.

As described above, the integrated installer 19 according to an exemplary embodiment installs a plurality of software programs based on a user's instruction and successively displays the initial setting dialogs 901 and 1001 at the foremost side for the software program that requires initial setting. Then, the integrated installer 19 successively executes initial settings based on user's operations using the initial setting dialogs 901 and 1001. Accordingly, the exemplary embodiment can lead the user to execute initial settings in an appropriate sequence without executing the processing for canceling the display of a dialog of the software program having been set to automatically start up. The exemplary embodiment can successively display the dialogs to be prioritized. Therefore, the exemplary embodiment can provide excellent operability for users.

According to the above-described exemplary embodiment, the integrated installer 19 installs a plurality of software programs. However, the number of software programs to be installed by the integrated installer 19 may alternatively be only one. Furthermore, according to the above-described exemplary embodiment, the system controls the display position and the display sequence of the initial setting dialogs 901 and 1001. However, the system can control the display area in addition to the display position. More over, the system can display the initial setting dialog 1001 at the fore side of the initial setting dialog 901, instead of deleting the display of the initial setting dialog 901.

### Third Exemplary Embodiment

A third exemplary embodiment of the present invention is described below. The above-described first exemplary embodiment deletes automatic startup registration information having been set beforehand by a user. The third exemplary embodiment differs from the first exemplary embodiment in that automatic startup registration information having been set beforehand by the user is not deleted and is editable. The third exemplary embodiment also differs from the first exemplary embodiment in part of the processing illustrated in FIG. 5.

More specifically, the host computer 1 and the printer 24 according to the third exemplary embodiment are similar in hardware configuration to those illustrated in FIG. 1. The software configuration for the host computer 1 according to the third exemplary embodiment is similar to that illustrated in FIG. 2. The software information 400 according to the third exemplary embodiment is similar to the example illustrated in FIG. 3. Furthermore, the third exemplary embodiment performs software program selection processing similar to that illustrated in FIG. 6 and performs initial setting completion determination processing similar to that illustrated in FIG. 7. Accordingly, reference numerals used in FIGS. 1 through 10 and 19 for the first exemplary embodiment are attached to similar portions in the description of the third exemplary embodiment. The differences between the first and third exemplary embodiments are further described below.

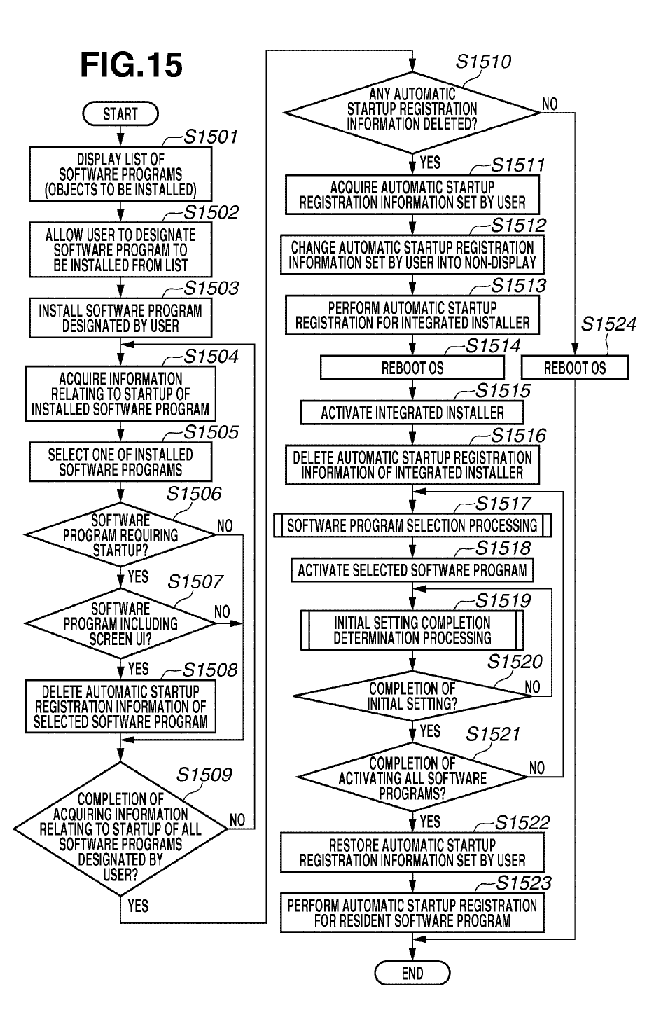

FIG. 15 is a flowchart illustrating example processing performed by the host computer 1.

Processing performed in steps S1501 through S1511 is similar to the processing in steps S501 through S511 illustrated in FIG. 5. In step S1501, the integrated installer 19 causes the display device 6 to display a list of software programs (objects to be installed). In step S1502, the integrated installer 19 allows a user to designate software program(s) to be installed with reference to the list of software programs (installation objects) displayed on the display device 6.

In step S1503, the integrated installer 19 installs the software program(s) designated by the user. In step S1504, the integrated installer 19 acquires software program activation information installed in step S1503 from the software information holding unit 305. As described above, the “automatic startup registration” value and the “screen UI” value are the information relating to activation.

In step S1505, the integrated installer 19 selects one of the installed software programs. In step S1506, the integrated installer 19 determines whether the selected software program requires activation based on the selected software program activation information. If the software program requires activation (YES in step S1506), the processing proceeds to step S1507. In step S1507, the integrated installer 19 determines whether the software program includes a screen UI with reference to the software program activation information selected in step S1505. If the integrated installer 19 determines that the software program selected in step S1505 includes the screen UI (YES in step S1507), the processing proceeds to step S1508. In step S1508, the integrated installer 19 deletes automatic startup registration information of the selected software program. Then, the processing proceeds to step S1509. If the integrated installer 19 determines that the selected software program does not require activation (NO in step S1506) or if the integrated installer 19 determines that the selected software program does not include any screen UI (NO in step S1507), the processing proceeds to step S1509.

When the processing proceeds to step S1509, the integrated installer 19 determines whether acquisition of activation related information is completed for all the software program(s) designated in step S1502. If the integrated installer 19 determines that acquisition of activation related information is not completed for all the designated software program(s) (NO in step S1509), the processing returns to step S1504. The integrated installer 19 repetitively performs the processing of steps S1504 through S1509. If the integrated installer 19 determines that acquisition of activation related information is completed for all the designated software program(s) (YES in step S1509), the processing proceeds to step S1510. In step S1510, the integrated installer 19 determines whether the processing of step S1508 has been executed.

If the integrated installer 19 has not executed the processing of step S1508 (NO in step S1510), the processing proceeds to step S1524. In step S1524, the integrated installer 19 performs rebooting of the OS 15 and terminates the processing of the routine illustrated in FIG. 15. If the integrated installer 19 has executed the processing of step S1508 (YES in step S1510), the processing proceeds to step S1511. In step S1511, the integrated installer 19 acquires, from the OS 15, the automatic startup registration information currently set by the user. As described above, the integrated installer 19 acquires information relating to “software program name”, “execution path”, and “screen to be displayed” as automatic startup registration information.

In step S1512, the integrated installer 19 edits the automatic startup registration information having been set by a user so as to prevent the software program whose automatic startup registration is set beforehand by the user from being activated in response to rebooting of the OS 15. More specifically, the integrated installer 19 causes the automatic startup registration deleting unit 302 to refer to automatic startup registration information stored in the automatic startup registration information holding unit 318 of the OS 15. Then, the integrated installer 19 causes the automatic startup registration deleting unit 302 to change the “screen to be displayed” value to “non-display” for all the automatic startup registration information (e.g., automatic startup registration information 322 and 323 according to the example illustrated in FIG. 2) of the software program(s) whose automatic startup registration is set beforehand by a user.

According to the above-described first exemplary embodiment, the integrated installer 19 deletes all the automatic startup registration information of the software program(s) whose automatic startup registration is set beforehand by a user in step S512. On the other hand, according to the above-described third exemplary embodiment, the integrated installer 19 changes the “screen to be displayed” value to “non-display” for all the automatic startup registration information of the software program(s) whose automatic startup registration is set beforehand by a user.

Processing performed in steps S1513 through S1521 is similar to the processing in steps S513 through S521 illustrated in FIG. 5. More specifically, in step S1513, the integrated installer 19 performs automatic startup registration for the integrated installer itself so that the integrated installer 19 can automatically start up after rebooting of the OS 15. In step S1514, the integrated installer 19 performs rebooting of the OS 15. In step S1515, the software program activation unit 317 activates the integrated installer 19 (automatic startup registration which has been performed in step S1513). In step S1516, the integrated installer 19 deletes the automatic startup registration information of the integrated installer 19 to prevent the integrated installer 19 from being activated in response to rebooting of the OS 15.

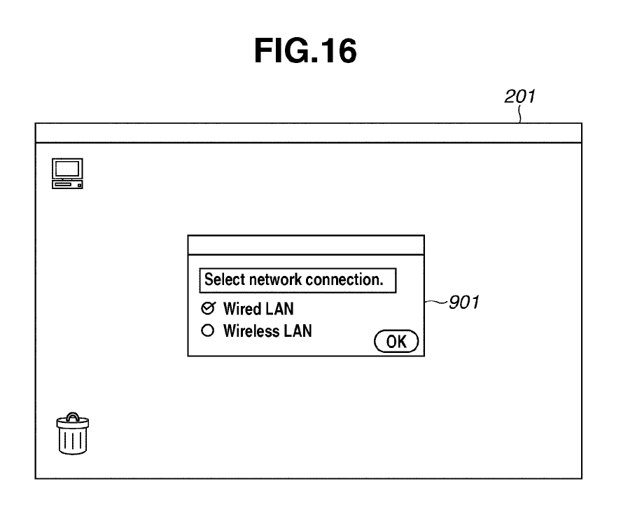

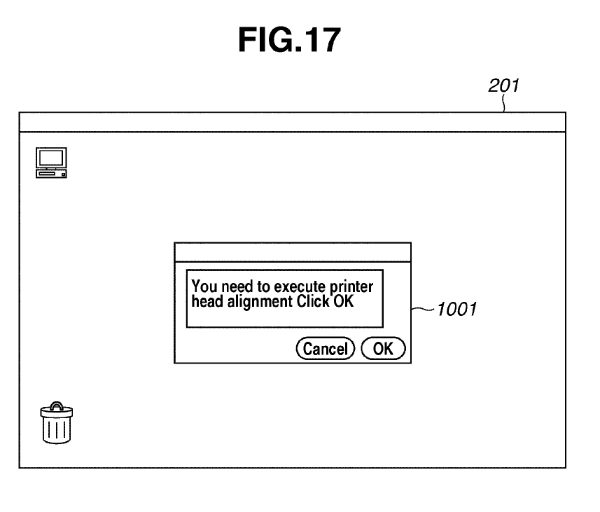

In step S1517, the integrated installer 19 performs software program selection processing for selecting software program to be activated. In step S1518, the integrated installer 19 activates the software program selected by the software program selection processing. After the software program selected in step S1517 is activated in step S1518, the integrated installer 19 causes the display device 6 to display the initial setting dialogs 901 and 1001 of the software program (refer to FIGS. 16 and 17).

In the exemplary embodiment, any software program whose automatic startup registration is set by a user can be subjected to the selection processing in step S1518. However, the timing for activating the registered software program is not limited to the above-described step. For example, similar to the first exemplary embodiment, the exemplary embodiment can activate the software program whose automatic startup registration is set by the user, after the initial setting for the newly installed software program is finished.

As described above, an exemplary embodiment can provide an activation unit and a display unit configured to perform the processing of step S1518.

In step S1519, the integrated installer 19 performs initial setting completion determination processing for the software program activated in step S1518. In step S1520, the integrated installer 19 determines whether the initial setting for the software program has been finished based on the result of the initial setting completion determination processing. The integrated installer 19 repetitively performs the processing of steps S1519 and S1520 until the initial setting for the software program activated in step S1518 is finished.

When the integrated installer 19 determines that the initial setting for the software program activated in step S1518 is finished (YES in step S1520), the processing proceeds to step S1521. In step S1521, the integrated installer 19 determines whether activation of all the software programs has been completed. If the integrated installer 19 determines that activation of all the software programs is not completed (NO in step S1521), the processing returns to step S1517 to repetitively perform the processing of steps S1517 through S1521. If the integrated installer 19 determines that activation of all the software programs is completed (YES in step S1521), the processing proceeds to step S1522.

When the processing proceeds to step S1522, the integrated installer 19 refers to the automatic startup registration information acquired in step S1511 and restores the content of the automatic startup registration information edited in step S1512. More specifically, the integrated installer 19 changes the “screen to be displayed” value of the automatic startup registration information edited in step S1512 from “non-display” to “display” and restores the automatic startup registration information of the software program having been set by the user to automatically start up.

Thus, the Web browser dialog 203 and the mailer software dialog 202 of the software program, which has been activated in a “non-display” state, are displayed on the screen 201. As described above, an exemplary embodiment can provide a display unit configured to perform the processing of step S1522. According to the above-described first exemplary embodiment, the integrated installer 19 re-registers the automatic startup registration information of the software program whose automatic startup registration is set beforehand by a user in step S522 to restore the automatic startup registration information. On the other hand, in the above-described third exemplary embodiment, the integrated installer 19 reedits the automatic startup registration information of the software program whose automatic startup registration is set beforehand by a user in step S1522 to restore the automatic startup registration information.

As described above, according to an exemplary embodiment, the system changes the “screen to be displayed” value of the automatic startup registration information to “non-display” for all the software programs whose automatic startup registration is set beforehand by a user (in step S1512,). Furthermore, the system restores the “screen to be displayed” value to “display” (in step S1522). Thus, the system can temporarily inhibit the Web browser dialog 203 and the mailer software dialog 202 from being displayed until the system completes the settings using the initial setting dialogs 901 and 1001. More specifically, an exemplary embodiment can realize a display inhibition unit configured to perform the processing of steps S1512 and S1522.

In step S1523, similar to step S523 illustrated in FIG. 5, the integrated installer 19 performs automatic startup registration for resident software program(s) having been installed. Then, the integrated installer 19 terminates the processing of the routine illustrated in FIG. 15.

As described above, the integrated installer 19 according to an exemplary embodiment enables a user to install a plurality of software programs and prevents software program(s) included in the automatic startup registration information set by the user beforehand from being displayed on the screen. Then, the integrated installer 19 restores (reedits) the automatic startup registration information having been set by the user after the initial setting for the software program(s) to be installed is completed.

FIGS. 16 through 18 illustrate example screens displayed on the display device 6 when the integrated installer 19 is used. Similar to the example screens illustrated in FIGS. 8 through 10, example screens illustrated in FIGS. 16 through 18 are sequentially displayed on the display device 6 when the integrated installer 19 is used to install software programs. It is now assumed that automatic startup registration for the Web browser dialog 203 and the mailer software dialog 202 illustrated in FIG. 19 is already set by a user. And, the installed software programs include network setting software program and printer setting software program.

FIG. 16 illustrates an example image displayed on the screen 201 of the display device 6 after rebooting of the OS 15. More specifically, the screen 201 displays the initial setting dialog 901 of the network setting software program initially selected by the software program selection processing in step S1517 illustrated in FIG. 15. The software program having been set for automatic startup registration by the integrated installer 19 at this moment does not include printer setting software program and miscellaneous software programs. However, the automatic startup registration information of the software program having been set by the user beforehand is changed to “non-display” in step S1512. Therefore, the dialog of the software program is not displayed on the screen 201.

FIG. 17 illustrates an example image displayed on the screen 201 of the display device 6, which follows the image illustrated in FIG. 16. According to the example image illustrated in FIG. 17, the initial setting dialog 1001 of the printer setting software program is displayed on the screen 201. The software program having been set for automatic startup registration by the integrated installer 19 at this moment does not include network setting software program and miscellaneous software programs. However, automatic startup registration information of the software program having been set by the user beforehand is changed to “non-display” in step S1512. Therefore, the dialog of the software program is not displayed on the screen 201. Furthermore, as the setting for a network setting printer is already finished, the setting of the printer can be performed successfully.

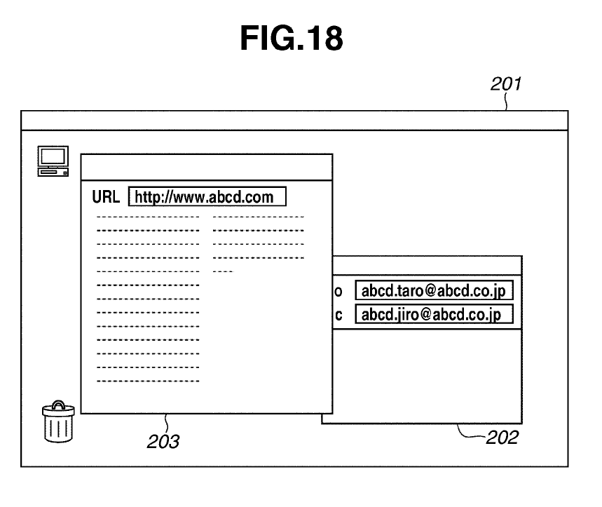

FIG. 18 illustrates an example image displayed on the screen 201 when the initial setting for the installed software program is finished and the setting of automatic startup registration having been set by the user is restored. After completing installation of the software program(s), the Web browser dialog 203 and the mailer software dialog 202 (automatic startup registration for which is “non-display”) are displayed on the screen 201. At this moment, the integrated installer 19 changes the “screen to be displayed” value of the automatic startup registration information for the Web browser dialog 203 and the mailer software dialog 202 to “display”, and performs automatic startup registration. Thus, the setting of the automatic startup registration having been set by the user can be restored.

As described above, according to an exemplary embodiment, the integrated installer 19 installs a plurality of software programs based on a user's instruction and sets the “screen to be displayed” value of the automatic startup registration information having been set by the user to “non-display.” Then, the integrated installer 19 causes the display device 6 to display the initial setting dialogs 901 and 1001 of the software program to be installed according to a predetermined sequence. After the integrated installer 19 has successively executed initial settings based on user's operations using the initial setting dialogs 901 and 1001, the integrated installer 19 changes the “screen to be displayed” value of the automatic startup registration information having been set by the user from “non-display” to “display” and restores the automatic startup registration information.

Accordingly, the exemplary embodiment can lead the user to execute initial settings in an appropriate sequence without executing the processing for deleting the automatic startup registration information of the software program(s) having been set to automatically start up. The exemplary embodiment can successively display the dialogs to be prioritized. Therefore, the exemplary embodiment can provide excellent operability for users.

According to the above-described exemplary embodiment, the integrated installer 19 installs a plurality of software programs. However, the number of software programs to be installed by the integrated installer 19 may be only one. Furthermore, according to the above-described exemplary embodiment, the system controls only the display sequence of the initial setting dialogs 901 and 1001. Alternatively, the system can control at least one of the display position and the display area in addition to the display sequence.

### Other Exemplary Embodiment

Respective units constituting the data processing apparatus and respective steps of the software program activation method according to the above-described exemplary embodiments of the present invention can be realized by a computer that executes program(s) stored in RAM or ROM. The present invention encompasses the program(s) and a computer-readable recording medium that stores the program(s).

For example, the present invention can be embodied as a system, an apparatus, a method, or a program carried by a storage medium. More specifically, the present invention can be applied to a system including a plurality of devices or a single device.

Furthermore, software program code (corresponding to the flowcharts illustrated in FIGS. 5 through 7, FIG. 11, and FIG. 15) for realizing the functions of the above-described exemplary embodiments can be supplied to a system or an apparatus including various devices. A computer (or CPU or micro-processing unit (MPU)) in the system or the apparatus can execute the program to operate the devices to realize the functions of the above-described exemplary embodiments.

Accordingly, the present invention encompasses the program code installable on a computer when the functions or processes of the exemplary embodiments can be realized by the computer.

In this case, the program code itself can realize the functions of the exemplary embodiments. The equivalents of programs can be used if they possess comparable functions. In this case, the type of program can be any one of object code, interpreter program, and OS script data.

Furthermore, the present invention encompasses supplying program code to a computer with a storage (or recording) medium storing the program code. A storage medium supplying the program can be selected from any one or more of a floppy disk, a hard disk, an optical disk, a magneto-optical (MO) disk, a compact disc-ROM (CD-ROM), a CD-recordable (CD-R), a CD-rewritable (CD-RW), a magnetic tape, a nonvolatile memory card, a ROM, and a DVD (DVD-ROM, DVD-R), for example.

The method for supplying the program includes accessing a web site on the Internet using the browsing function of a client computer, when the web site allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different web sites. Namely, the present invention encompasses World Wide Web (WWW) servers that allow numerous users to download the program files so that the functions or processes of the present invention can be realized on their computers.

Enciphering the programs of the present invention and storing the enciphered programs on a CD-ROM or comparable recording medium is an exemplary method when the programs of the present invention are distributed to the users. The authorized users (i.e., users fulfilling predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Moreover, an operating system (OS) or other application software program running on a computer can execute part or the whole of actual processing based on instructions of the programs.

Additionally, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or the whole of the processing so that the functions of the above-described exemplary embodiments can be realized.

According to the above-described exemplary embodiments, when the system activates a plurality of software programs including one or more newly installed software programs to accomplish the installation work for the newly installing software program(s), the system can display images relating to the plurality of software programs according to a display pattern corresponding to the software programs to be activated. The system can determine the display pattern of the images relating to the plurality of software programs considering the types of the software programs to be activated. Therefore, the system can appropriately display the images relating to the plurality of software programs. The system enables a user to easily perform settings for the installed software program(s).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-211453 filed Aug. 14, 2007, which is hereby incorporated by reference herein in its entirety.

What is claimed is:

1. A data processing apparatus comprising:
an installation unit configured to install programs;
an activation unit configured to activate a plurality of programs including one or more programs installed by the installation unit to complete an installation work for the one or more programs; and
a display unit configured to cause a display device to display an image relating to the program activated by the activation unit,
wherein the display unit displays a screen relating to the plurality of programs activated by the activation unit according to a display pattern corresponding to the plurality of programs, to prevent a screen display for the programs whose installation work is already completed from interfering with user's operation for program newly installed by the installation unit on an initial setting screen.

2. The data processing apparatus according to claim 1, further comprising a selection unit configured to select program to be activated by the activation unit, from the plurality of programs, according to a content of settings required for the plurality of programs, when the installation unit installs the plurality of programs,
wherein the activation unit activates the plurality of programs installed by the installation unit in a sequence of the programs selected by the selection unit, and
the display unit displays an initial setting screen for the plurality of programs installed by the installation unit according to the sequence of the programs activated by the activation unit.

3. The data processing apparatus according to claim 2, further comprising a determination unit configured to determine whether a condition required to perform an initial setting for the plurality of programs installed by the installation unit is fulfilled,
wherein if the determination unit determines that the condition is fulfilled the activation unit activates program that requires fulfillment of the condition.

4. The data processing apparatus according to claim 1, further comprising an initial setting completion determination unit configured to determine, when the program installed by the installation unit is activated by the activation unit, whether an initial setting for the activated program is completed, wherein the activation unit successively activates a remainder of the plurality of programs installed by the installation unit after the initial setting completion determination unit determines that the initial setting for the program is completed.

5. The data processing apparatus according to claim 1, wherein the activation unit prioritizes the activation of the program installed by the installation unit over the activation of the program whose installation work is already completed, and the display unit prioritizes the display of the initial setting screen for the program installed by the installation unit over the display of the program whose installation work is already completed.

6. The data processing apparatus according to claim 1, further comprising a setting unit configured to perform setting for causing the activation unit to automatically activate resident program after the activation unit completes activating all the programs installed by the installation unit.

7. The data processing apparatus according to claim 6, further comprising
a canceling unit configured to cancel the setting for causing the activation unit to automatically activate the program whose installation work is already completed, and
a resetting unit configured to restore the setting canceled by the canceling unit after the program installed by the installation unit is activated by the activation unit,
wherein the display unit displays a screen relating to the program whose installation work is already completed after the setting is restored by the resetting unit.

8. The data processing apparatus according to claim 1, further comprising a display inhibition unit configured to temporarily prevent the display unit from displaying a screen relating to the program whose installation work is already completed even after the installation completed program is activated by the activation unit,
wherein the display unit displays the screen relating to the program whose installation work is already completed after the display unit displays the initial setting screen for the program installed by the installation unit and user's operation on the initial setting screen is finished.

9. The data processing apparatus according to claim 1, wherein the display unit displays the initial setting screen of the program installed by the installation unit at the fore side of the screen relating to the program whose installation work is already completed.

10. A method for activating program, comprising:
installing programs;
activating a plurality of programs including one or more installed programs to complete an installation work for the one or more installed programs;
causing a display device to display an image relating to the activated program, and
displaying a screen relating to the activated plurality of programs according to a display pattern corresponding to the plurality of programs, to prevent a screen display for the programs whose installation work is already completed from interfering with user's operation for newly installed program on an initial setting screen.

11. The program activation method according to claim 10, further comprising
selecting program to be activated, from the plurality of programs, according to a content of settings required for the plurality of programs, when the plurality of programs are installed,
activating the installed plurality of programs in a sequence of the selected programs, and
displaying an initial setting screen for at least the installed plurality of programs according to the sequence of the activated programs.

12. The program activation method according to claim 11, further comprising
determining whether a condition required to perform an initial setting for the installed plurality of programs is fulfilled, and
if the condition is fulfilled, activating program that requires fulfillment of the condition.

13. The program activation method according to claim 10, further comprising
determining, when the installed program is activated, whether an initial setting for the activated program is completed, and
successively activating a remainder of the installed plurality of programs after it is determined that the initial setting for the program is completed.

14. The program activation method according to claim 10, further comprising
prioritizing the activation of the installed program over the activation of the program whose installation work is already completed, and
prioritizing the display of the initial setting screen for the installed program over the display of the program whose installation work is already completed.

15. The program activation method according to claim 10, further comprising performing setting for automatically activating resident program after completing activation of all the installed programs.

16. The program activation method according to claim 15, further comprising
canceling the setting for automatically activating the program whose installation work is already completed,
restoring the canceled setting after the installed program is activated, and
displaying a screen relating to the program whose installation work is already completed after the setting is restored.

17. The program activation method according to claim 10, further comprising
temporarily preventing a display device from displaying a screen relating to the program whose installation work is already completed even after the installation completed program is activated, and
displaying the screen relating to the program whose installation work is already completed after the initial setting screen for the installed program is displayed and user's operation on the initial setting screen is finished.

18. The program activation method according to claim 10, further comprising displaying the initial setting screen of the installed program at the fore side of the screen relating to the program whose installation work is already completed.

19. A computer readable storage medium storing a computer program for causing a computer to execute processing for activating program; the computer program comprising:
computer-executable instructions for installing programs;
computer-executable instructions for activating a plurality of programs including one or more installed programs to complete an installation work for the one or more installed programs;
computer-executable instructions for causing a display device to display an image relating to the activated program, and
computer-executable instructions for displaying a screen relating to the activated plurality of programs according to a display pattern corresponding to the plurality of programs, to prevent a screen display for the programs whose installation work is already completed from interfering with user's operation for newly installed program on an initial setting screen.
